(19) United States
(12) Patent Application Publication
(10) Pub. No.: US 2014/0107864 A1
(43) Pub. Date: Apr. 17, 2014

(54) VEHICLE CENTRAL PROCESSING SYSTEM INTEGRATED WITH A MOBILE DEVICE

(71) Applicant: LIBERA, INC., Jamestown, NY (US)

(72) Inventor: Albert Cecchini, Jamestown, NY (US)

(73) Assignee: Libera, Inc., Jamestown, NY (US)

(21) Appl. No.: 13/649,259

(22) Filed: Oct. 11, 2012

(51) Int. Cl. G06F 17/00

(52) U.S. Cl. CPC G06F 17/00
USPC 701/2; 701/1; 701/51

(57) ABSTRACT

A vehicle central processing module (CPM) integrated with a mobile device such as a cellular telephone. For one embodiment a vehicle control system includes a vehicle-CPM integrated with a cellular telephone. For one embodiment a cellular telephone includes vehicle-CPM securely and uniquely paired and communicatively coupled to an electrical network of a vehicle. The electrical network of the vehicle is connected to one or more electrical systems of the vehicle and provides operational monitoring and control of the electrical systems through the cellular telephone. A method is provided for controlling the electrical systems of a vehicle using a software application executed on a digital processing system of a cellular telephone.

### FIELD OF THE INVENTION

Embodiments of the invention relate generally to the field of vehicle monitoring and control systems and more specifically to systems embedding a vehicle central processing system within a mobile device such as a cellular telephone.

### BACKGROUND OF THE INVENTION

A typical vehicle monitoring and control system includes an electronic network that provides connections to the vehicle's electric systems including power windows, seats, door locks, alarms, vehicle sensors (tire pressure, water temperature, oil pressure, fuel level, etc.), motor controls (timing, fuel mixture, etc.), power distribution to the wheels, anti-lock breaking systems, traction control, stabilization control, heating, air conditioning, remote starting, and audio/video devices. The electric systems are monitored and controlled by a vehicle central processing system or Central Processing Module (CPM). The electronic network and the vehicle CPM are integrated with the vehicle.

FIG. 1 illustrates a typical vehicle with a control scheme in accordance with the prior art. Vehicle control scheme 100, shown in FIG. 1, includes a vehicle 114 having an integrated electronic network 118 coupled to one or more electrical devices of the vehicle. The vehicle also has a central processing module 126 for monitoring and controlling the electrical devices of the vehicle. The central processing module 126 has a serial data port connection 130 coupling a data interface module 134 and a transceiver module 138 to the central processing module 126 and the electronic network 118 of the vehicle 114. An electronic smart device such as a computer or smart device 142 communicates wirelessly with the transceiver module 138. The central processing module 126 may also include an analog connection for use with non-electronic network equipped vehicles.

A data interface module 134 may be used to provide data translation between the vehicle's electronic network 118 and the central processing module 126. The transceiver module 138 may include a data encryption/decryption unit 154. A Global Positioning System (GPS) unit 158 capable of identifying the location of the vehicle 114 may be implemented within the transceiver module 138.

The smart device 142 may be used to monitor and operate any of the electrical systems of the vehicle by communicating with the central processing module 126. Such electrical systems controlled by the central processing module 126, may include, for example, a vehicle alarm system, door locks, remote starter system, audio/video display systems, communications systems, and location and navigation systems among others. The central processing module 126 may communicate with the electrical systems of the vehicle using various communication protocols. For example, the central processing module 126 may communicate micro voltage measurements to control one or more vehicle monitoring systems, and may communicate stepping voltage to control one or more vehicle servo control systems.

The transceiver module 138 provides vehicle information to the smart device 142 which may include engine and transmission information, tachometer readings, water temperature, oil pressure, battery charge level, climate control status, tire pressure as well as any other vehicle information measured by an electrical system. The smart device 142 and the transceiver module 138 may exchange information including codes, confirmations, instructions, and vehicle status and performance information.

U.S. Pat. No. 7,725,129, issued to Grunhold, discloses the state of the art vehicle control scheme using a Central Processing Module (CPM) 126. Such vehicle control schemes are disadvantageous for several reasons. For example, the trend toward increasing numbers of electrical devices in the vehicle necessitates a corresponding increase in the complexity of the vehicle's CPM. The increasing complexity of the vehicle CPM results in an increase in the cost of vehicle manufacture and maintenance. Moreover, the vehicle CPM is not readily adaptable to modification to allow for the addition of electrical devices to the vehicle or changes in the firmware, software, and/or BIOS, which results in increased cost to modify the electrical systems and network of the vehicle. Further, the vehicle CPM is not readily accessible, which increases the cost to repair or replace. Additionally the vehicle CPM is susceptible to unauthorized access and the vehicle can be stolen because the CPM is part of the vehicle. Such disadvantages are addressed by embodiments of the invention.

### SUMMARY OF THE INVENTION

Embodiments of the invention eliminate the CPM as an integral part of a vehicle. The preferred embodiment provides for a vehicle-CPM integrated within a cellular telephone or other portable communication device such as a laptop computer or tablet computer. For one embodiment, a cellular telephone includes a CPM securely communicatively coupled to an electronic network of a vehicle. This secure coupling is in the form of unique pairing between the vehicle transceiver and CPM of the cellular telephone. It can be accomplished via methods known to the art such as Blue Tooth pairing, Wi-Fi security keys, GUID matching, SIM card serial number matching, and the like. Once paired, the cell phone based CPM provides monitoring and operational control of the vehicle electrical systems through direct communication of information between the cellular telephone and part or all of the electrical systems of the vehicle. Vehicle electrical systems include sensors as well as electrical devices which control functions and operations of the motor, brakes, stabilization systems, and the like.

For alternative embodiments, CPM functionality is implemented using software, firmware, hardware, SIM, SIP, or combinations thereof. For one embodiment, a method is provided for controlling the electrical systems of a vehicle using a software application executed on a digital processing system of a cellular telephone. In alternative embodiments, the (CPM) may be implemented as one or more of a software, firmware, Disk, CD-ROM, DVD, solid state, SIM, SIP based application executed on a digital processing system of the cellular telephone.

For one embodiment, the CPM functionality is coupled to the electronic network of the vehicle through a wired connection of a cellular telephone docking station implemented within the vehicle. Additionally or alternatively, the CPM functionality may be coupled to the electrical network of the vehicle through a wireless or cellular communication connection.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 illustrates a vehicle control scheme in accordance with the prior art;

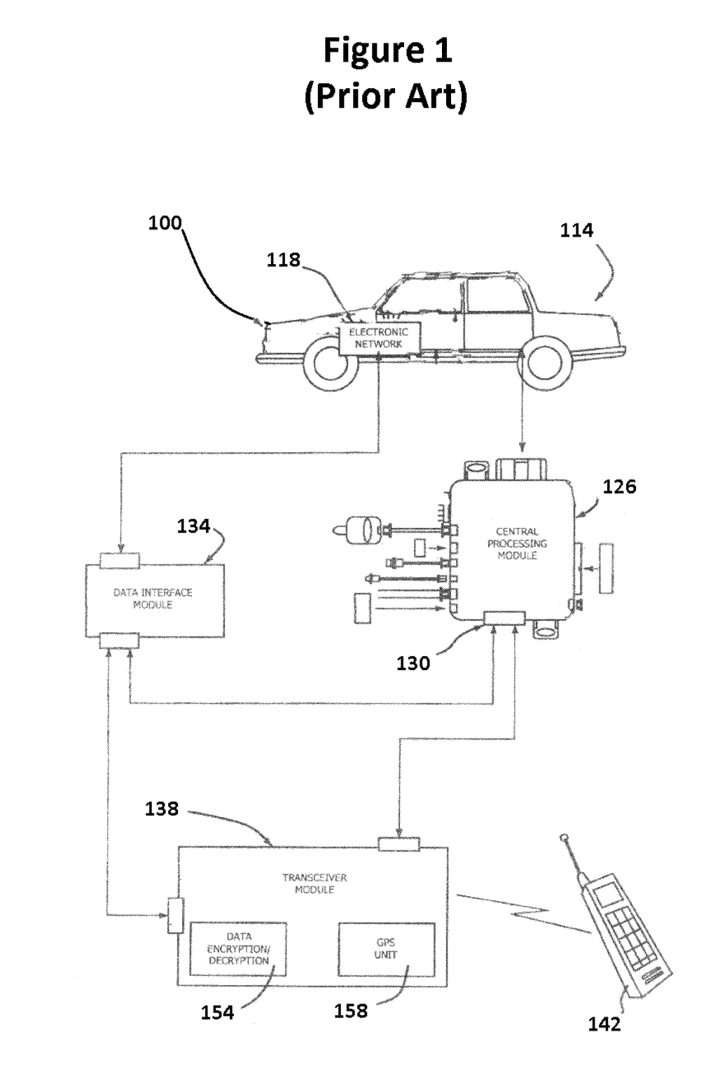

FIG. 2 illustrates a vehicle CPM system in which vehicle control functionality is integrated with a cellular telephone in accordance with an embodiment of the invention;

FIG. 3 illustrates a vehicle CPM in which vehicle control functionality is integrated with a cellular telephone in accordance with an alternative embodiment of the invention;

FIG. 4 illustrates a process by which the electrical system of a vehicle is accessed and used in accordance with an embodiment of the invention; and

FIG. 5 illustrates an exemplary computing system implementing a vehicle Central Processing Module (CPM) in accordance with one embodiment of the invention.

### DETAILED DESCRIPTION

A vehicle Central Processing Module (CPM) integrated with a cellular telephone or other portable communication device is disclosed. For one embodiment a cellular telephone includes a CPM that allows a user to monitor and control electrical systems of the vehicle through the cellular telephone.

For one embodiment of the invention the vehicle CPM is implemented as a software application executed on a digital processing system of the cellular telephone.

For one embodiment, the vehicle CPM is coupled to the electronic network of the vehicle through a wired connection of a cellular telephone docking station implemented within the vehicle.

Additionally or alternatively, the vehicle CPM may be coupled to the electrical network of the vehicle through a wireless or cellular communication connection.

For one embodiment, the mobile device, such as a cellular telephone, and a transceiver module of a vehicle communicate information about the vehicle status. For various alternative embodiments, the mobile device CPM communicates information which may be related to a GPS location system for determining the location of the vehicle, Navigation, Mapping, photographing, video recording, Internet radio, MP3, passenger movie entertainment, teleconferencing, internet, data storage, or office work environment.

In the following description, numerous specific details are set forth. However, it is understood that embodiments of the invention may be practiced without these specific details. In other instances, well-known architectures, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

Embodiments of the invention are applicable in a variety of settings in which a vehicle CPM system is employed to control the electrical systems of a vehicle.

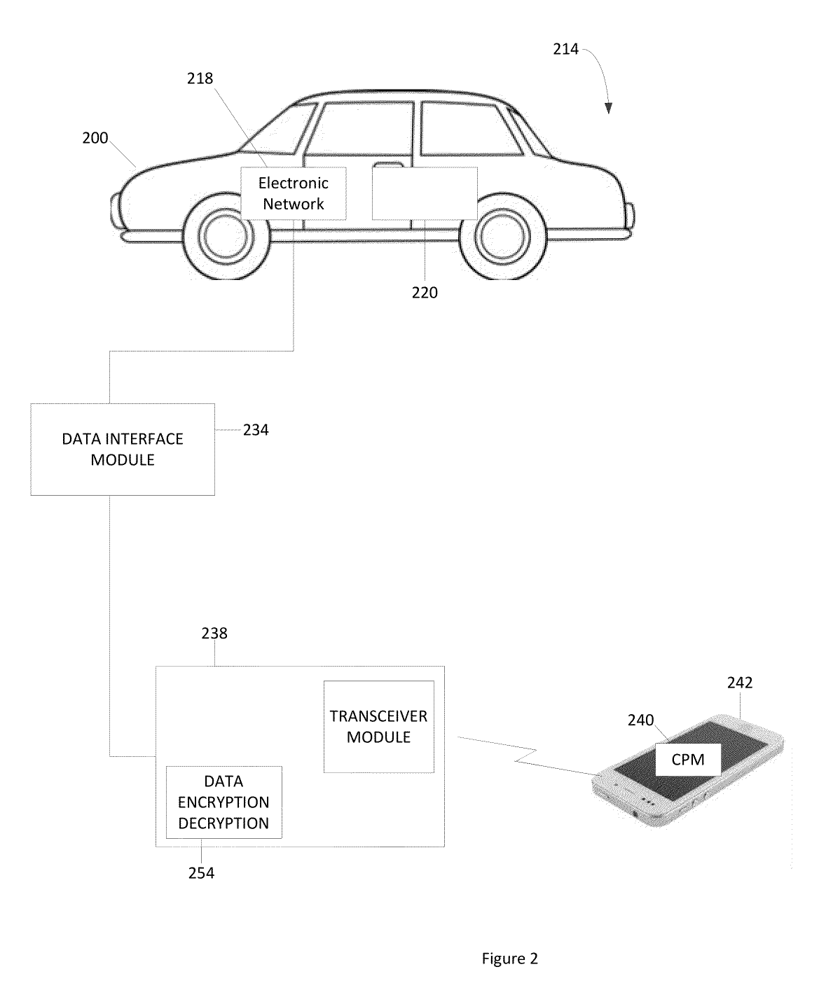

FIG. 2 illustrates a vehicle CPM system in which a vehicle CPM is integrated with a cellular telephone in accordance with an embodiment of the invention. System 200, shown in FIG. 2 also includes a vehicle 214. The vehicle 214 includes an electronic network 218 connected to one or more electrical devices 220 of the vehicle 214. As noted above the electrical devices may include audio and video display systems for presenting audio and video content. The audio and video systems may include audio and video display devices such as video display monitors and audio speakers as well as access, storage, and presentation functionality for presenting audio and video content. The vehicle also includes an interface, not shown, that provides a physical wired connection for communicating information between the electronic network 218 of the vehicle and cellular telephone 242. The interface may be, for example, a cellular telephone docking station.

System 200 includes a vehicle Central Processing Module (CPM) 240 integrated with the cellular telephone 242. For one embodiment of the invention, the CPM 240 may be implemented as a software application executed on a processing system of the cellular telephone 242. In an alternative embodiment, the CPM 240 may be implemented as a dedicated vehicle-CPM integrated with cellular telephone 242. System 200 provides means for communicatively coupling the CPM with the electronic network of the vehicle. The means for communicatively coupling the CPM with the electronic network of the vehicle include a cellular telephone docking station, wireless connection, cellular connection, or combinations thereof. System 200 also includes means for communicatively coupling the CPM with the electronic network of the vehicle. For example, means for communicatively coupling the CPM with the electronic network of the vehicle may include one or more of a cellular telephone docking station, wireless connection, cellular connection, and combinations and equivalents thereof.

Cellular telephone 242 may also be connected to the vehicle through a data interface module 234 connected to the vehicle interface to provide data translation between the vehicle's electronic network 218 and the CPM within the cellular telephone. Cellular telephone 242 may also include a display for displaying information received to the CPM from the electronic network 218, such as information received from vehicle sensors. The cellular telephone 242 may be connected to a transceiver module 238 that may include a data encryption/decryption unit 254. The CPM may communicate with the electrical systems of the vehicle using various communication protocols as known in the art.

The integration of the CPM with the cellular telephone 242 allows a user to control the vehicle through the cellular telephone. For one embodiment, the vehicle 214, having no on-board vehicle-CPM, cannot be activated or operated except through the cellular phone. Additionally, the CPM, integrated within the cellular telephone, can be easily accessed for modification or repair thus reducing vehicle maintenance costs. Moreover, the vehicle 214 need not include many electrical devices typically resident in the vehicle with conventional schemes. For example, the vehicle 214 need not include audio, video, or navigation systems, but may only include presentation devices for audio/video/navigation content (e.g., display screens and speakers) as access, storage, and presentation functionality for audio/video/navigation content may reside on or through the cellular telephone 242.

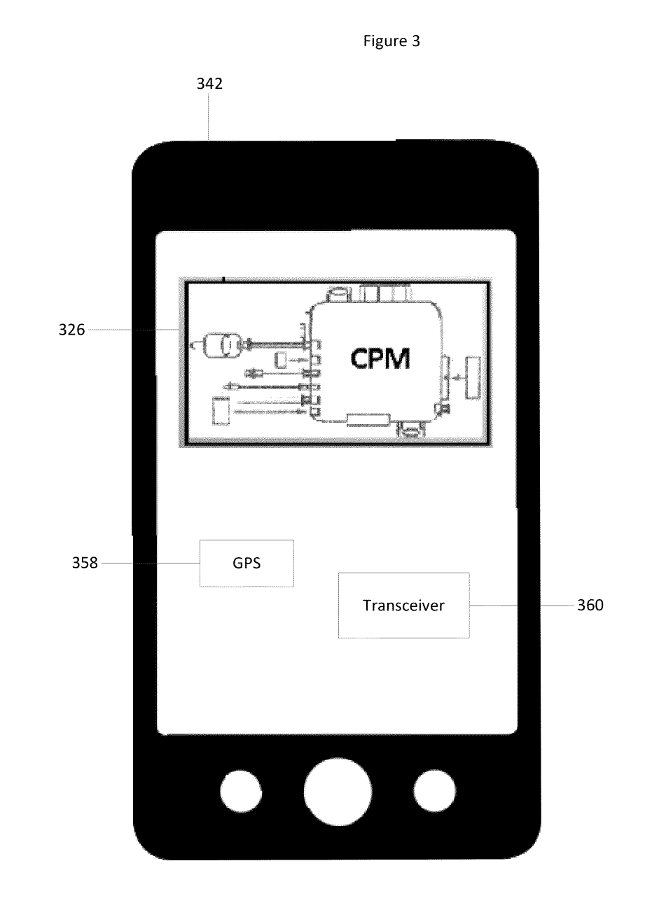

As noted above, the vehicle CPM may be coupled to the electrical network of the vehicle through a wireless communication connection. The communication can be via wireless capability, such as Bluetooth or Wi-Fi, or using the cellular telephone's cellular capabilities in combination with a cellular receiving unit in the vehicle. FIG. 3 illustrates a system in which vehicle CPM functionality is integrated with a cellular telephone in accordance with one such embodiment of the invention. As shown in FIG. 3, a vehicle CPM 326 is integrated within a cellular telephone 342. As described above in reference to FIG. 2, the CPM 326 controls and monitors a vehicle, not shown, that has an electronic network connected to one or more electrical devices of the vehicle. However, for one embodiment, there is no interface implemented in the vehicle. That is, the vehicle need not include an interface such as a cellular telephone docking station.

For such an embodiment, a transceiver module of the vehicle communicates wirelessly with a transceiver module 360 of the cellular telephone 342 to exchange information between the electronic network of the vehicle and the CPM 326 integrated within cellular telephone 342. For alternative embodiments, a vehicle-control system may include a cellular telephone docking station or other interface implemented in the vehicle as well as a transceiver module integrated with the cellular telephone thus providing both wired and wireless communication between the CPM and the electronic network of the vehicle.

For one embodiment, the transceiver module 360 may include a data encryption/decryption unit, not shown, and a Global Positioning System (GPS) unit 358.

Cellular telephone 342 may also include a data interface module and a display for displaying information received to the CPM 326 from the electronic network of the vehicle, such as, information received from vehicle sensors.

As noted above, integration of the CPM within the cellular telephone allows a user to control the vehicle through the cellular telephone. For embodiments implementing wireless communication between the CPM integrated within the cellular telephone and the electronic network of the vehicle, the user may remotely control and monitor the vehicle. For example, a user may remotely activate/deactivate vehicle systems such as locking or other security systems. With a securely paired cellular telephone to a specific vehicle, the user may also remotely monitor the vehicle status by receiving information from vehicle systems such as information from vehicle sensor devices.

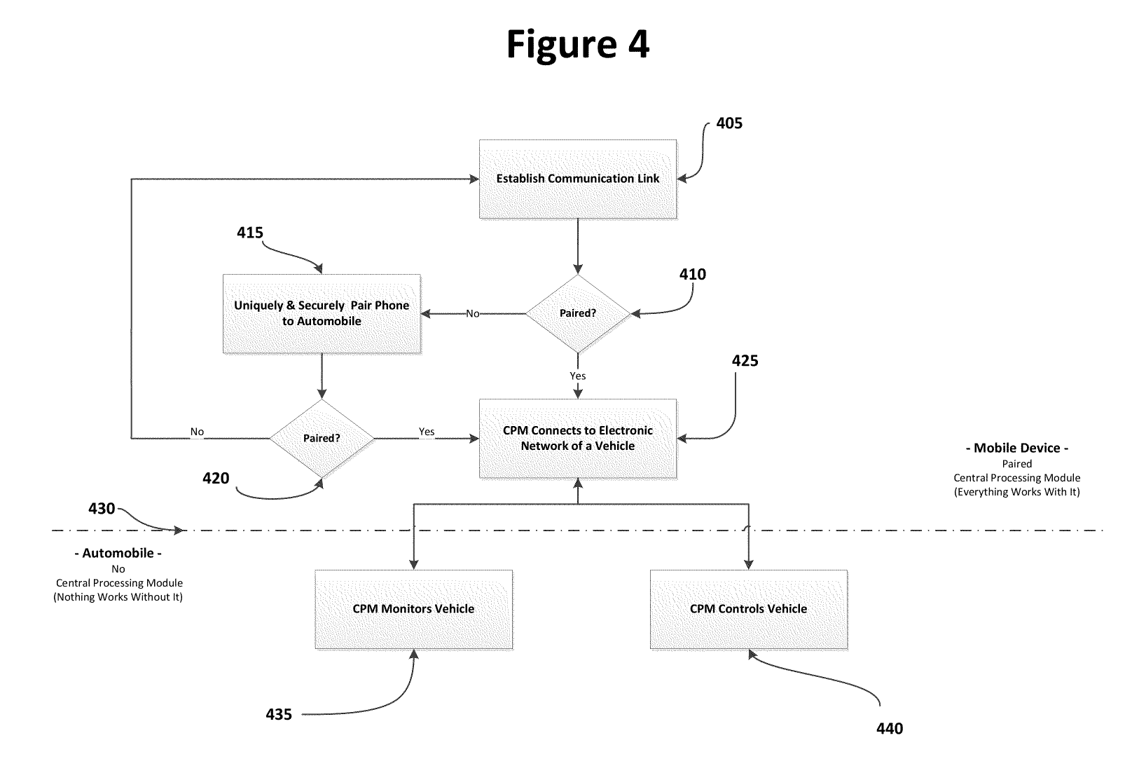

FIG. 4 illustrates a process by which the electrical system of a vehicle is accessed and used in accordance with an embodiment of the invention. The electrical systems accessed and used may include vehicle activation systems, locking and other security systems, audio/video/navigation systems, vehicle sensor systems, vehicle diagnostic systems, motor controls (timing, fuel mixture, etc.), power distribution to the wheels, anti-lock breaking systems, traction control, and stabilization control, among others. The systems accessed may also include one or more vehicle monitoring systems, and one or more vehicle servo control systems. Process 400, shown in FIG. 4 begins with operation 405 in which a cellular telephone having integrated CPM is activated and a communication link is established. At operation 410 a determination is made as to whether the cellular phone is uniquely and securely paired to the vehicle. If the cellular phone is not uniquely and securely paired to the vehicle, then a unique and secure pairing is effected at operation 415 and verified at operation 420.

Upon a determination that the cellular phone is uniquely and securely paired to the vehicle, the CPM connects to the electronic network of the vehicle at operation 425.

Division 430 illustrates that the vehicle is controlled and monitored through the CPM integrated within the cellular phone and that the vehicle cannot be controlled or monitored without the CPM uniquely and securely paired to the vehicle. At operation 435 the CPM is used to monitor the vehicle. For example, the user may be presented with information provided by one or more electrical systems of the vehicle, which may include readings from one or more sensors.

At operation 440, the CPM is used to control the vehicle. Prior to activation of the paired cellular telephone, the electrical systems of the vehicle cannot be accessed. For example, an activated security system may not be deactivated other than through use of the specific cellular telephone paired to the vehicle. If the vehicle ignition or activation system is controlled by the integrated CPM, then the vehicle itself is non-operational prior to activation of the specific cellular telephone.

The vehicle, in turn, can be started from the cellular telephone with the phone's CPM monitoring the sensors and then controlling all aspects of the vehicle functionality such as engine fuel to air mixture, timing, power curve, speed regulation, anti-lock brakes, stabilization systems, charging, and the like.

As discussed above, the systems of the vehicle accessed by embodiments of the invention may include one or more vehicle monitoring systems, and one or more vehicle servo control systems. The systems accessed may include, but are not limited to: engine monitoring system, transmission monitoring system, tachometer, fuel mixture monitoring system, O2 monitoring system, electrical motor monitoring system, regenerative braking monitoring system, ABS monitoring system, stabilization monitoring system, shock absorber monitoring system, water temperature monitoring system, oil pressure monitoring system, battery monitoring system, climate control monitoring system, tire pressure monitoring system, security monitoring system, fuel level monitoring system, crash prevention monitoring system, sonar proximity monitoring system, torque monitoring system, hybrid power sharing monitoring system, lights monitoring system, fluid level monitoring system.

Vehicle notification may also be communicated between the mobile device and the CPM. The CPM notifications communicated may include, but are not limited to: engine status notifications, transmission status notifications, RPM status notifications, fuel mixture status notifications, O2 status notifications, electrical motor status notifications, regenerative braking status notifications, ABS status notifications, stabilization status notifications, shock absorber status notifications, water temperature status notifications, oil pressure status notifications, battery status notifications, climate status notifications, climate control notifications, windshield wiper status notifications, speed notifications, cruise control status notifications, lighting status notifications, tire pressure status notifications, tire inflator status notifications, security status notifications, fuel level notifications, lighting notifications, crash prevention status notifications, sonar proximity notifications, audio/video notifications, navigation notifications, automatic breaking status notifications, torque status notifications, hybrid power sharing status notifications, electric vehicle notifications.

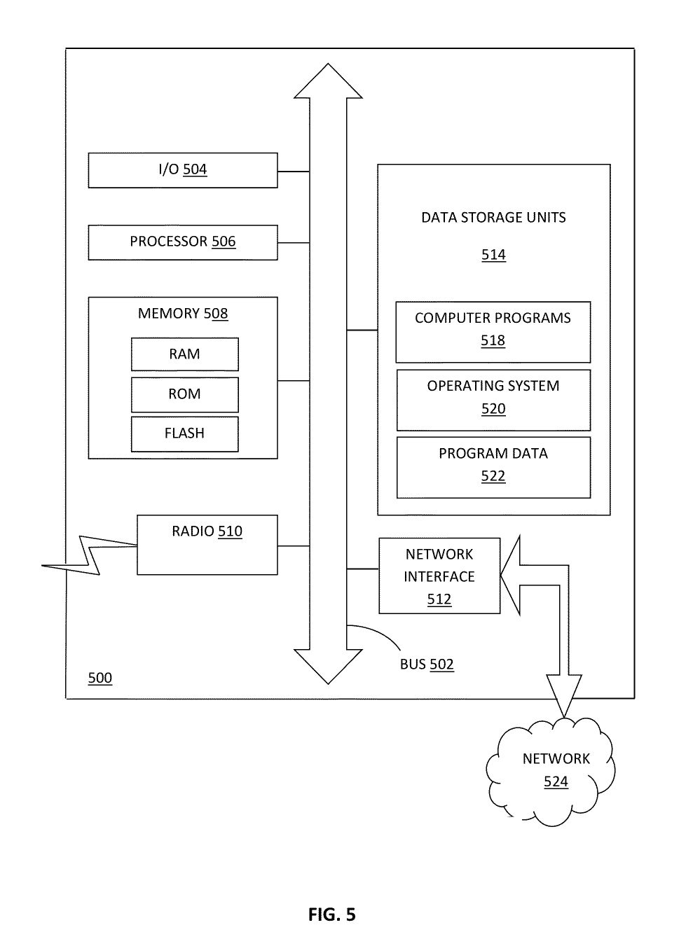

FIG. 5 illustrates an exemplary computing system implementing vehicle Central Processing Module (CPM) in accordance with one embodiment of the invention. The computing system shown in FIG. 5 includes a computer 500 running hardware, software, and/or firmware that facilitate performance of the methods in accordance with embodiments of the invention.

The computer 500 includes a processor 506 in communication with a computer readable storage medium, where the computer readable storage medium is any medium that stores information for retrieval later by the processor 506. In an exemplary embodiment, the computer readable storage medium includes memory 508 and data storage units 514. Memory 508 may be a fast-access memory and is used to run program instructions executable by the processor 506. Memory 508 also may be random access memory (RAM), read only memory (ROM), and/or flash memory.

Data storage units 514 may be physical devices and are used to store any data and instructions that may be accessed by the processor 506, such as program data 522 and instructions for computer programs 518 and an operating system 520. Data storage units 514 may be an optical medium, a magnetic medium such as a floppy disk, a compact disc (CD), a digital video disk (DVD), and/or a solid-state medium such as RAM, ROM, and flash memory.

The computer programs 518 are any computer software that provides vehicle control and monitoring. The computer programs 518 may also include vehicle system functionality. For example, computer programs 518 may include vehicle navigation functionality as well as audio/visual content and audio/visual content presentation functionality as discussed above. The systems and methods described herein are preferably implemented by one of the computer programs 518, which is in the form of computer instructions that when executed by a processor cause the processor to implement each of the steps of the methods described herein. The methods described herein in accordance with various alternative embodiments may also be implemented by processing hardware-based or firmware-based instructions that when executed by a processor also cause the processor to implement each of the steps of the methods described herein.

The computer 500 also includes a radio 510 or another type of communications device for wirelessly transmitting and receiving data. In addition, the computer 500 may operate in a networked environment using logical connections to other computers and communication devices via network 524. The computer 500, other computers, and communication devices may be any mobile device, or a personal computer, a server, a router, a network PC, a peer device, a printer, or other common network nodes. When used in a LAN or WLAN networking environment, the computer 500 is connected to the other computers and communication devices via the LAN or WLAN through a network interface 512.

The computer 500 also includes input/output devices 504 for providing input to the processor 506, the memory 508, the radio 510, the storage units 514, the network interface 512, and other electrical components of the computer 500 and the output of the electrical components of the computer 500 to other electrical components of the computer 500, other electrical components of other computers, or a user of the computer 500 or other computers. For example, a display device provides output of the electrical components to a user.

A bus 502 and other circuitry assist in connecting the input/output devices (I/O) 504 to various electrical components of the computer 500. The above-mentioned applications programs and the electrical components of the computer are made of computer hardware, software, firmware, or any combination thereof. The communications among such components occur in the form of signals including electronic signals, electromagnetic signals, optical signals, or any combination thereof.

Though various embodiments of the present invention have been described above, it should be understood that embodiments have been presented by way of example, and not limitation. A person of ordinary skill in the art will recognize that there are various changes that can be made to the present invention without departing from the spirit and scope of the present invention. Therefore, the invention should not be limited by any of the above-described example embodiments, but should be defined only in accordance with the following claims and equivalents of the claimed invention.

Embodiments of the invention have been described as including various operations. Many of the processes are described in their most basic form, but operations can be added to or deleted from any of the processes without departing from the scope of the invention. For example, for various alternative embodiments, the vehicle's integrated onboard CPM may have been reduced in capability to monitor and/or control only a subset of the electrical systems of the vehicle. For various embodiments the cell phone based CPM may monitor and control complementary aspects that the onboard CPM no longer contains. For example, the vehicle may be started or activated by means other than the integrated CPM.

The operations of the invention may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software. The invention may be provided as a computer program product that may include a machine-readable medium having stored thereon instructions, which may be used to program a computer, smart phone, pad, or other electronic devices to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, SIMs, SIPs, or other types of media/machine-readable medium suitable for storing electronic instructions. Moreover, the invention may also be downloaded as a computer program product, wherein the program may be transferred from a remote device to a requesting device by way of data signals embodied in a carrier wave or other propagation medium via a communication cell (e.g., a modem or network connection).

The foregoing is merely illustrative of the principals of this invention, and various modifications can be made by those skilled in the art without departing from the scope and spirit of the invention.

1. A system for monitoring the electronic network connected to one or more electrical systems of a vehicle, comprising:
a mobile device;
a vehicle central processing module (CPM) integrated with the mobile device, said CPM programmed to provide vehicle-monitoring, notification, and control functionality; and
means for communicatively coupling the CPM with the electronic network of a vehicle.

2. The system of claim 1, wherein the mobile device is a cellular telephone and the CPM is implemented as one or more of a software, firmware, disk, CD-ROM, DVD, solid state, SIM, SIP based application executed on a digital processing system of the cellular telephone.

3. The system of claim 1, wherein the means for communicatively coupling the CPM with the electronic network of the vehicle is one or more of a cellular telephone docking station, wireless connection, or cellular connection.

4. The system of claim 1, wherein the mobile device includes a data interface module that provides data translation between the electronic network of the vehicle and the CPM within the mobile device.

5. The system of claim 1, wherein the one or more electrical systems of the vehicle are one or more electrical systems selected from the group consisting of a vehicle alarm system, door locking system, remote starter system, audio/video display system, vehicle diagnostic system, communications system, location system, navigation system, and one or more vehicle monitoring systems, and one or more vehicle servo control systems.

6. The system of claim 3, wherein the mobile device establishes a paired secure communication link between the electronic network of the vehicle through a transceiver module of the vehicle and the mobile device.

7. The system of claim 6, wherein the mobile device and the transceiver module of the vehicle communicate information related to the vehicle selected from the group comprising security codes, confirmations, and instructions in order to pair the mobile device with the vehicle.

8. The system of claim 5, wherein the one or more vehicle monitoring systems are one or more vehicle monitoring systems selected from the group comprising engine monitoring system, transmission monitoring system, tachometer, fuel mixture monitoring system, O2 monitoring system, electrical motor monitoring system, regenerative braking monitoring system, ABS monitoring system, stabilization monitoring system, shock absorber monitoring system, water temperature monitoring system, oil pressure monitoring system, battery monitoring system, climate control monitoring system, tire pressure monitoring system, security monitoring system, fuel level monitoring system, crash prevention monitoring system, sonar proximity monitoring system, torque monitoring system, hybrid power sharing monitoring system, lights monitoring system, fluid level monitoring system.

9. The system of claim 6, wherein the mobile device and the transceiver module of the vehicle communicate CPM notifications from the mobile device to the vehicle selected from a group comprising engine status notifications, transmission status notifications, RPM status notifications, fuel mixture status notifications, O2 status notifications, electrical motor status notifications, regenerative braking status notifications, ABS status notifications, stabilization status notifications, shock absorber status notifications, water temperature status notifications, oil pressure status notifications, battery status notifications, climate status notifications, climate control notifications, windshield wiper status notifications, speed notifications, cruise control status notifications, lighting status notifications, tire pressure status notifications, tire inflator status notifications, security status notifications, fuel level notifications, lighting notifications, crash prevention status notifications, sonar proximity notifications, audio/video notifications, navigation notifications, automatic breaking status notifications, torque status notifications, hybrid power sharing status notifications, electric vehicle notifications.

10. The system of claim 6, wherein the mobile device and the transceiver module of the vehicle communicate CPM control commands from the mobile device to the vehicle selected from a group comprising engine control commands, transmission control commands, RPM control commands, fuel mixture control commands, O2 control commands, electrical motor control commands, regenerative braking control commands, ABS control commands, stabilization control commands, shock absorber control commands, water temperature control commands, oil pressure control commands, battery control commands, climate control commands, windshield wiper control commands, speed notifications, cruise control, lighting control commands, tire inflator control commands, security control commands, lighting control commands, crash prevention control commands, sonar proximity commands, audio/video feeds, navigation feeds, map feeds, tachometer feeds, speed feeds, light status feeds, tire pressure feeds, oil pressure feeds, automatic breaking control commands, torque control commands, hybrid power control commands, electric vehicle motor control commands.

11. The system of claim 1 wherein
The CPM is composed of one or more applications implemented within the mobile device, the one or more applications providing functionality to the electronic network of the vehicle through the communicatively coupling means, wherein the functionality is effected through a presentation device of the vehicle.

12. A method comprising:
activating an integrated vehicle-monitoring, notification, and control functionality implemented as a vehicle central processing module (CPM) integrated within a mobile device;
establishing a communication link between the integrated CPM and an electronic network of a vehicle, the electronic network connected to one or more electrical systems of the vehicle; and
communicating information between the integrated CPM and the electronic network of the vehicle.

13. The method of claim 12, wherein the step of activating further comprises:
activating a CPM implemented as one or more of a software, firmware, disk, CD-ROM, DVD, solid state, SIM, SIP based application executed on a digital processing system of the cellular telephone.

14. The method of claim 12 wherein the step of establishing a communication link between the CPM with the electronic network of a vehicle is effected using one or more of a cellular telephone docking station, wireless connection, or cellular connection.

15. The method of claim 12, wherein the step of establishing a communication link between the integrated CPM and an electronic network of a vehicle further comprises:
establishing a communication link between the integrated CPM and an electronic network of the vehicle connected to one or more electrical systems of the vehicle selected from the group comprising a vehicle alarm system, door locking system, remote starter system, audio/video display system, vehicle diagnostic system, communications system, location system, navigation system, and one or more vehicle monitoring systems, and one or more vehicle servo control systems.

16. The method of claim 14, wherein the step of establishing a communication link between the integrated CPM and an electronic network of a vehicle, further comprises:
establishing a paired secure communication link between the electronic network of the vehicle through a transceiver module of the vehicle and the mobile device.

17. The method of claim 16 wherein the step of communicating information between the integrated CPM and the electronic network of the vehicle includes allowing the CPM of the mobile device to monitor and translate the vehicle electrical systems through sensor electrical signals.

18. The method of claim 17 wherein the step of communicating information between the integrated CPM and the electronic network of the vehicle further comprises:
the CMP translating the vehicle electrical system signals and providing notifications to the operator through audio and visual displays of the vehicle electrical network.

19. The method of claim 16 wherein the step of communicating information between the integrated CPM and the electronic network of the vehicle further comprises:
the CMP controlling the electrical systems of the vehicle electrical network by providing electrical signals which drive vehicle electrical systems selected from a group of display, audio, and servo motor electrical devices.

20. The method of claim 12 wherein the, wherein the step of activating further comprises:
activating control functionality of the CPM implemented as one or more applications within the mobile device to provide control functionality to the electronic network of the vehicle.
